(19) United States
(12) Patent Application Publication
(10) Pub. No.: US 2025/0141095 A1
(43) Pub. Date: May 1, 2025

(54) WIRING BODY AND SMART GLASSES

(71) Applicant: TDK Corporation, Tokyo (JP)

(72) Inventors: Tomoyuki GOI, Tokyo (JP); Matsumi WADA, Tokyo (JP); Kenichi TEZUKA, Tokyo (JP); Hiroshi SHINGAI, Tokyo (JP)

(73) Assignee: TDK Corporation, Tokyo (JP)

(21) Appl. No.: 18/931,920

(22) Filed: Oct. 30, 2024

(30) Foreign Application Priority Data
Oct. 31, 2023 (JP) 2023-186996
Oct. 9, 2024 (JP) 2024-177452

(51) Int. Cl. H01Q 1/27; G02B 27/01; G02C 11/00; H01Q 1/38

(52) U.S. Cl. CPC H01Q 1/273; G02B 27/017; G02C 11/10; H01Q 1/38; G02B 2027/0178

(57) ABSTRACT

A wiring body includes a base board, a ground pattern provided on the base board, and a conductor portion including a first conductor pattern and a second conductor pattern containing metal. The ground pattern is a conductor pattern extending so as to form a planar surface. The second conductor pattern is a mesh-like conductor pattern connected to the first conductor pattern. The conductor portion is able to be arranged in a bent state.

### CROSS-REFERENCE TO RELATED APPLICATIONS

This application is based upon and claims the benefit of priority from Japanese Patent Application No. 2023-186996, filed on Oct. 31, 2023, and Japanese Patent Application No. 2024-177452, filed on Oct. 9, 2024, the entire contents of each are incorporated herein by reference.

### TECHNICAL FIELD

The present disclosure relates to a wiring body and smart glasses.

### BACKGROUND

Conventionally, smart glasses equipped with an antenna and a base board are known for glasses (e.g., Transparent and Flexible Antenna for Wearable Glasses Applications, Seungman Hong, IEEE TRANSACTIONS ON ANTENNAS AND PROPAGATION, VOL. 64, NO. 7, July 2016). In these smart glasses, a transparent electrode is arranged as an antenna on a lens body.

### SUMMARY

According to an aspect of the present disclosure, there is provided a wiring body including: a base board; a ground pattern provided on the base board; and a conductor portion including a first conductor pattern and a second conductor pattern containing metal, wherein the ground pattern is a conductor pattern extending so as to form a planar surface, wherein the second conductor pattern is a mesh-like conductor pattern connected to the first conductor pattern, and wherein the conductor portion is able to be arranged in a bent state.

According to an aspect of the present disclosure, there is provided a wiring body including: a base board; a ground pattern provided on the base board; and a conductor portion including a first conductor pattern and a second conductor pattern containing metal, wherein the ground pattern is a conductor pattern extending so as to form a planar surface, wherein the second conductor pattern is a mesh-like conductor pattern connected to the first conductor pattern, and wherein the conductor portion is able to be arranged in a state where at least a part of the first conductor pattern and at least a part of the second conductor pattern extend in different directions.

According to an aspect of the present disclosure, there are provided smart glasses including: a pair of lens bodies; temple arms arranged on both sides of the pair of lens bodies; and the above-described wiring body, wherein the second conductor pattern is disposed at the lens body and the base board is disposed at the temple arm.

### BRIEF DESCRIPTION OF THE DRAWINGS

FIG. 1 is a perspective view showing smart glasses 1 including a wiring body according to an embodiment of the present disclosure.

FIG. 2 is a schematic view showing an example of an aspect in which the wiring body is attached to the smart glasses 1.

FIGS. 3A to 3C are views showing the wiring body.

FIGS. 4A and 4B are cross-sectional views showing a cross-sectional structure when an antenna portion is mounted on the lens body.

FIG. 5 is a table showing experimental results.

FIG. 6 is a diagram showing an example of a structure for projecting a video onto the lens body.

FIG. 7 is a view showing smart glasses according to a modified example.

FIG. 8 is a view showing smart glasses according to a modified example.

FIG. 9 is a view showing smart glasses according to a modified example.

FIG. 10 is a schematic view showing an example of an aspect in which the wiring body of the modified example is attached to the smart glasses.

FIGS. 11A to 11C are views showing the wiring body shown in FIG. 10.

FIG. 12 is a schematic view showing an example of an aspect in which the wiring body of a modified example is attached to the smart glasses.

FIGS. 13A to 13C are views showing the wiring body shown in FIG. 12.

FIG. 14 is a schematic view showing an example of an aspect in which the wiring body of a modified example is attached to the smart glasses.

FIGS. 15A to 15C are views showing the wiring body shown in FIG. 14.

### DETAILED DESCRIPTION

Here, in the smart glasses as described above, it is necessary to suppress the visibility of a conductor pattern arranged on a lens body from the outside. Moreover, it is necessary to improve the antenna characteristics of the wiring body used in the smart glasses.

Therefore, an objective of the present disclosure is to provide a wiring body and smart glasses capable of suppressing the visibility of a conductor pattern of an antenna and improving the characteristics of the antenna.

According to an aspect of the present disclosure, it is possible to provide a wiring body and smart glasses that can suppress the visibility of a conductor pattern of an antenna and improve the characteristics of the antenna.

Hereinafter, some embodiments of the present disclosure will be described in detail. However, the present disclosure is not limited to the following embodiments.

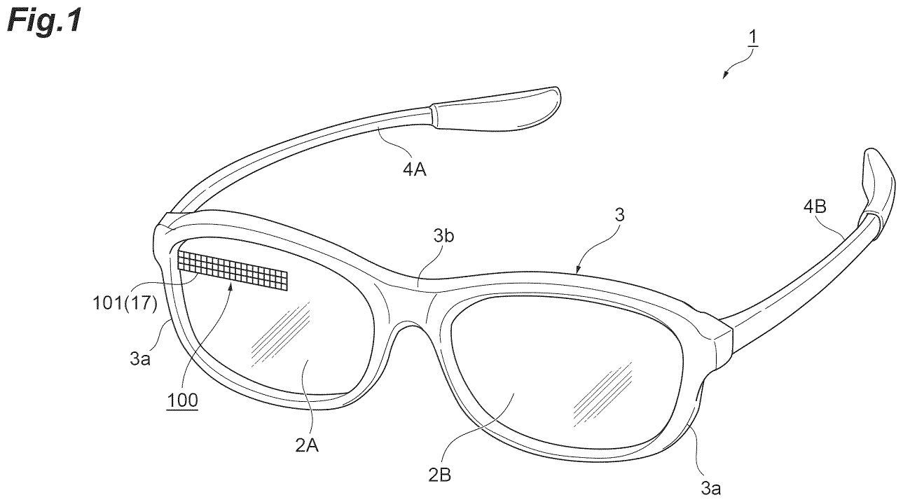

FIG. 1 is a perspective view showing smart glasses 1 including a wiring body 100 according to an embodiment of the present disclosure. The smart glasses 1 are a type of wearable device having smartphone-like features while maintaining the shape of traditional glasses. The smart glasses 1 are a device for allowing a user to display visual information directly in a field of view or to perform a manipulation through voice recognition, gesture recognition, a touch panel, and the like. The smart glasses 1 may include augmented reality (AR) glasses, mixed reality (MR) glasses, and the like for superimposing a video in the field of view of the real world. In addition, the wiring body 100 may be applied to a head-mounted device and may be employed not only in a glasses-type device as shown in FIG. 1, but also in devices of a goggle type, a hat type, a helmet type, and the like.

The smart glasses 1 include a pair of lens bodies 2A and 2B, a frame 3, a pair of temple arms 4A and 4B, and a wiring body 100. The lens body 2A and the temple arm 4A are provided on a right-eye side, and the lens body 2B and the temple arm 4B are provided on a left-eye side.

The frame 3 includes a pair of rims 3a and 3a and a bridge 3b. The rims 3a and 3a are portions holding the lens bodies 2A and 2B. The bridge 3b is a portion connecting the pair of rims 3a and 3a. In addition, the frame 3 may be a rimless frame. The lens bodies 2A and 2B face the eyeballs of the user wearing the smart glasses 1. The temple arms 4A and 4B are arranged on both sides of the pair of lens bodies 2A and 2B. The temple arms 4A and 4B are portions extending backward from the left and right rims 3a and 3a and placed around the user's ears.

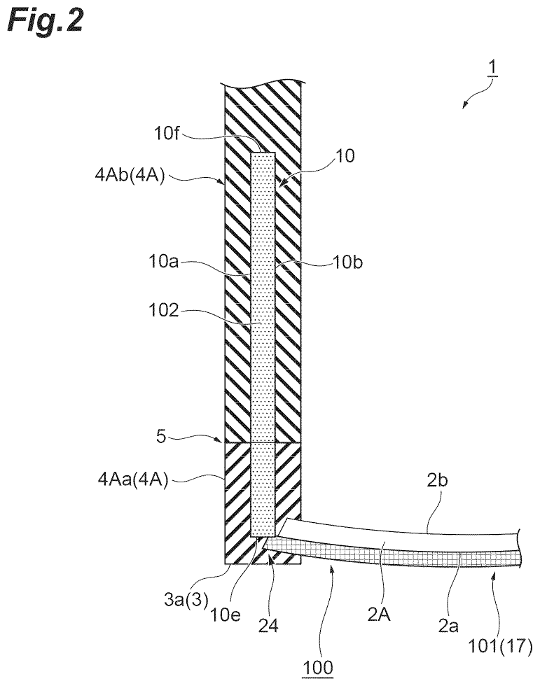

In the present embodiment, the wiring body 100 is provided for the lens body 2A and the temple arm 4A on the right-eye side. However, a position where the wiring body 100 is provided is not limited and the wiring body 100 may be provided on the left-eye side. FIG. 2 is a schematic diagram showing an example of an aspect in which the wiring body 100 is attached to the smart glasses 1. In FIG. 2, a state in which the structure of the right-eye side of the smart glasses 1 is seen from above is shown and a state of the inside of the temple arm 4A and the frame 3 is shown. As shown in FIG. 2, the wiring body 100 includes an antenna portion 101 functioning as an antenna and a circuit portion 102 including an electronic circuit. The antenna portion 101 is provided on the lens body 2A and the circuit portion 102 is provided in the temple arm 4A. The antenna portion 101 is bent in the connection portion with the circuit portion 102. The lens body 2A has a main surface 2a opposite to the user's eyeball and a main surface 2b facing the eyeball. The antenna portion 101 may be arranged on the main surface 2a of the lens body 2A. The main surface 2a of the lens body 2A is bent, but the antenna portion 101 is arranged on the main surface 2a in a bent state corresponding to a bent shape. In addition, the antenna portion 101 is arranged to extend in the left and right directions along the edge portion of the upper side near an edge portion of the upper side of the lens body 2A. However, the position and length of the antenna portion 101 on the lens body 2A are not particularly limited.

The circuit portion 102 is arranged inside the temple arm 4A. The circuit portion 102 is arranged to extend in a direction in which the temple arm 4A extends. In addition, the circuit portion 102 is provided inside the temple arm 4A and configured not to be externally exposed. However, the circuit portion 102 may not necessarily be provided inside the temple arm 4A, and, for example, a part or all of the circuit portion 102 may be exposed from the surface of the temple arm 4A. In addition, the temple arm 4A has a first portion 4Aa extending backward from the rim 3a of the frame 3 and a second portion 4Ab extending further backward from the first portion 4Aa and placed around the user's ear. In the present embodiment, the first portion 4Aa of the temple arm 4A is integrally formed with the rim 3a of the frame 3. Between the first portion 4Aa and the second portion 4Ab of the temple arm 4A, a joint portion 5 for enabling the second portion 4Ab of the temple arm 4A to be opened and closed is provided. The circuit portion 102 may have a configuration that can be bent according to a folding operation of the second portion 4Ab of the temple arm 4A at the joint portion 5, for example, by employing a flexible base board or the like at least at a location corresponding to the joint portion 5. Moreover, the circuit portion 102 may be configured to fit into the first portion 4Aa of the temple arm 4A.

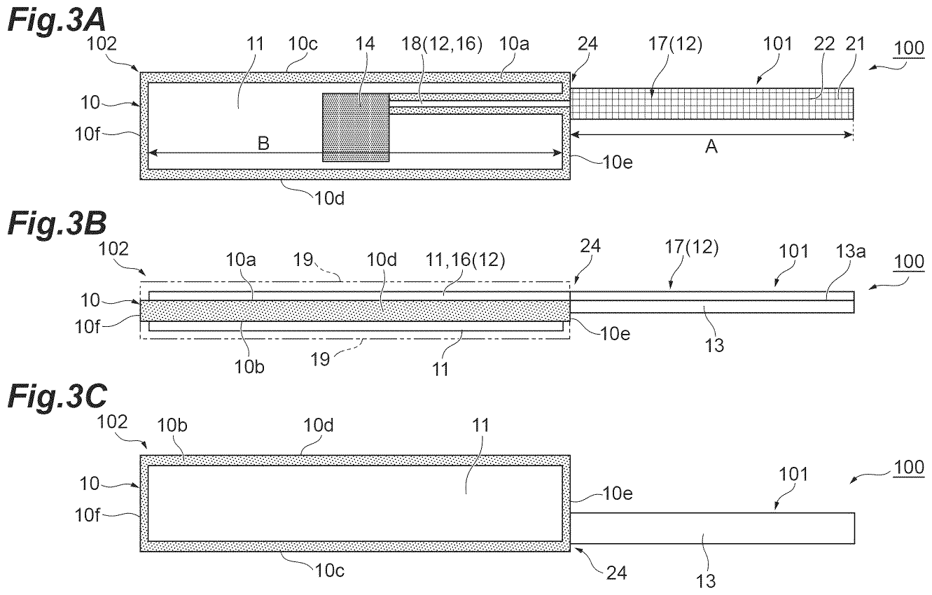

Next, a configuration of the wiring body 100 will be described with reference to FIGS. 3A to 3C. FIGS. 3A to 3C show the wiring body 100 in which the antenna portion 101 and the circuit portion 102 extend in the same direction without bending. FIG. 3A is a view showing a front surface 10a side of the base board 10 of the wiring body 100. FIG. 3B is a view showing a side surface 10d side of the base board 10 of the wiring body 100. FIG. 3C is a diagram showing a back surface 10b side of the base board 10 of the wiring body 100. As shown in FIGS. 3A to 3C, the wiring body 100 includes a base board 10, a ground pattern 11, and a conductor portion 12. The wiring body 100 in the present embodiment functions as a monopole antenna.

The base board 10 is a member serving as a base for the above-described circuit portion 102. That is, the circuit portion 102 includes the base board 10, the conductor pattern formed on the base board 10, and the electronic components mounted on the base board 10. The base board 10 has a rectangular plate-like shape extending along the temple arm 4A. The base board 10 includes a front surface 10a, a back surface 10b, and four side surfaces 10c, 10d, 10e, and 10f. The front surface 10a and the back surface 10b are main surfaces facing each other in a thickness direction. The side surfaces 10c and 10d constitute side surfaces of long sides and face each other in a lateral direction. The side surfaces 10e and 10f constitute side surfaces of short sides and face each other in a longitudinal direction. Various electronic components 14 are mounted on the front surface 10a of the base board 10. In the present embodiment, an RFIC is implemented as the electronic component 14. In addition, the electronic components 14 (not shown) other than RFIC may be mounted on the front surface 10a of the base board 10.

The material of the base board 10 is not particularly limited, but, for example, a glass epoxy base board, a BT resin base board, a Teflon base board, a ceramic base board, a flexible base board, and the like may be employed. A thickness of the base board 10 is not particularly limited, but may be set to 0.1 to 2 mm. A length of the base board 10 will be described below. On the front surface 10a and the back surface 10b of the base board 10, resist layers 19 are formed to cover the ground pattern 11 and the first conductor pattern 16 (see FIG. 3B). In FIG. 3B, the resist layer 19 is indicated by an imaginary line. In FIGS. 3A and 3C, a state in which the resist layer 19 is omitted and other members are exposed is shown. The resist layer 19 includes a resin, and, for example, is an alkali-developed resist, a UV-curable resist, a thermosetting resist, or the like. The thickness of the resist layer 19 is not particularly limited, but may be set to 10 to 40 μm.

In the present embodiment, in a state in which the wiring body 100 is incorporated in the smart glasses 1, the front surface 10a is arranged on an outer side and the back surface 10b is arranged on an inner side with respect to the user's head (see FIG. 2). The side surface 10c is arranged on an upper side and the side surface 10d is arranged on a lower side. However, the orientation of the base board 10 is not particularly limited, but the front surface 10a may be arranged on an inner side, the back surface 10b may be arranged on an outer side, the side surface 10c may be arranged on the lower side, and the side surface 10d may be arranged on the upper side. The side surface 10e is arranged on a front side of the user's head and the side surface 10f is arranged on a back side thereof.

The ground pattern 11 is a conductor pattern provided on the base board 10. The ground pattern 11 is a region that is electrically grounded. The ground pattern 11 may be provided on the front surface 10a of the base board 10 (see FIGS. 3A and 3B) and provided on the back surface 10b of the base board 10 (see FIGS. 3B and 3C). In the present embodiment, the ground pattern 11 of the front surface 10a and the back surface 10b is a pattern in which the outer edges extend along the four side surfaces 10c, 10d, 10e, and 10f of the base board 10 and is formed so that the outer edge of the ground pattern 11 is located inside the outer edge of the base board 10. The width of the ground pattern 11 per side is not particularly limited, but may be set to 3 to 20 mm. In addition, in the front surface 10a, the ground pattern 11 is insulated from the first conductor pattern 16 when the ground pattern 11 is spaced apart from the first conductor pattern 16 to be described below.

The ground pattern 11 is a conductor pattern (a solid pattern) extending so as to form a planar surface on the front surface 10a and the back surface 10b of the base board 10. The conductor pattern extending so as to form a planar surface is a pattern formed by crimping a metallic foil on the front surface 10a and the back surface 10b. That is, the conductor pattern extending so as to form a planar surface is not a pattern in which a conductor portion and a non-conductor portion alternate within a certain range like a mesh-like pattern, but is a pattern in which the conductor portion continuously spreads within a certain range. Moreover, the ground pattern 11 is a conductor pattern of a thick film having a thickness of the order of microns, unlike a thin film having a thickness of the order of nanos such as a transparent electrode.

The ground pattern 11 may contain metal. The ground pattern 11 may contain at least one type of metal selected from the group consisting of copper, nickel, cobalt, palladium, silver, gold, platinum, and tin or may contain copper. The ground pattern 11 may be metal plating formed by a plating method. The ground pattern 11 may further contain a non-metallic element such as phosphorus to the extent that appropriate conductivity is maintained. The thickness of the ground pattern 11 is not particularly limited, but may be set to 10 to 100 μm.

The conductor portion 12 includes a first conductor pattern 16 and a second conductor pattern 17 containing metal. The first conductor pattern 16 is a pattern formed on the front surface 10a of the base board 10. The second conductor pattern 17 is a conductor pattern constituting the antenna portion 101. The antenna portion 101 is configured by connecting the substrate 13 to the side surface 10e of the front side of the base board 10 and forming the second conductor pattern 17 on the substrate 13. The second conductor pattern 17 is formed on the front surface 13a on the front surface 10a side of the base board 10 (see FIG. 3B) within the substrate 13. In the present embodiment, the antenna portion 101 has a rectangular shape of a longitudinal direction identical to a longitudinal direction of the base board 10. In addition, as the materials of the first conductor pattern 16 and the second conductor pattern 17, materials similar to that of the ground pattern 11 may be employed.

In the present embodiment, the first conductor pattern 16 has a transmission line 18 that electrically connects the electronic component 14 and the second conductor pattern 17. The transmission line 18 extends toward the side surface 10e of the front side from the electronic component 14. A width of the transmission line 18 is not particularly limited, but may be set to, for example, 50 to 1000 μm. In addition, the first conductor pattern 16 may have a pattern (not shown) connected to the electronic component 14. The first conductor pattern 16 is a conductor pattern (a solid pattern) extending so as to form a planar surface on the front surface 10a of the base board 10. In addition, the configuration of the first conductor pattern 16 is not particularly limited, but may be a mesh-like pattern. The thickness of the first conductor pattern 16 is not particularly limited, but may be similar to that of the ground pattern 11. Moreover, an impedance adjustment element may be provided in the connection portion between the first conductor pattern 16 and the second conductor pattern 17 for an impedance adjustment between the antenna portion 101 and the circuit portion 102. Examples of the impedance adjustment element include an inductance element and a capacitance element. These adjustment elements may be connected in series between the first conductor pattern 16 and the second conductor pattern 17 or may be connected between the connection portion between the first conductor pattern 16 and the second conductor pattern 17 and the ground pattern 11.

The second conductor pattern 17 is a mesh-like conductor pattern connected to the first conductor pattern 16. The mesh-like second conductor pattern 17 includes a first conductive wire 21 and a plurality of second conductive wires 22. The first conductive wire 21 is a straight conductor extending in parallel to the longitudinal direction of the antenna portion 101. The plurality of first conductive wires 21 are spaced apart from each other in the lateral direction of the antenna portion 101. The plurality of first conductive wires 21 are spaced at equal pitches. The second conductive wire 22 is a straight conductor extending in parallel to the lateral direction of the antenna portion 101. The plurality of second conductive wires 22 are spaced apart from each other in the longitudinal direction of the antenna portion 101. The plurality of second conductive wires 22 are spaced at equal pitches. Thicknesses of the conductive wires 21 and 22 are not particularly limited, but may be set to, for example, 1 to 5 μm. Moreover, pitches of the conductive wires 21 and 22 are not particularly limited, but may be set to, for example, 50 to 300 μm. The first conductive wire 21 does not have to be parallel to the longitudinal direction as long as it extends in the longitudinal direction, and the second conductive wire 22 does not have to be parallel to the lateral direction as long as it extends in the lateral direction. Moreover, the second conductor pattern 17 may be a pattern in which the first conductive wire 21 extends at an angle with respect to the longitudinal direction, the second conductive wire 22 extends at an angle in a direction opposite to that of the first conductive wire 21 with respect to the longitudinal direction, and the first and second conductive wires 21 and 22 intersect to form a mesh.

Sheet resistance of the second conductor pattern 17 may be 1Ω/□ or less or 0.5Ω/□ or less. The sheet resistance is electrical resistance of a thin film of uniform thickness and is the resistance between two opposing sides when the film is square. In addition, a method of measuring sheet resistance is not particularly limited, but, for example, may be measured using a four-terminal surface measurer.

A length of the second conductor pattern 17 is denoted by A and a length of the ground pattern 11 is denoted by B (see FIG. 3A). Moreover, the wavelength of the resonant frequency is denoted by A. Here, the wavelength λ is a value calculated using the resonant frequency and the effective relative dielectric constant. The effective dielectric constant is a value obtained from relative dielectric constants of a material and an air layer constituting the lens bodies 2A and 2B as effective values of the relative dielectric constants of the lens bodies 2A and 2B. In this case, Inequality (1) is satisfied. The length A of the second conductor pattern 17 is a dimension of the antenna portion 101 in a longitudinal direction. The length B of the ground pattern 11 is a dimension of the ground pattern 11 in a longitudinal direction. Although not particularly limited, the length A of the second conductor pattern 17, for example, may be set in a range in which a ratio of A−λ/4 to λ/4 satisfies ±50%. The length of the base board 10 may be set to a range that satisfies the following Inequality (1).

$$A - λ / 4 < B - A \qquad ( 1 )$$

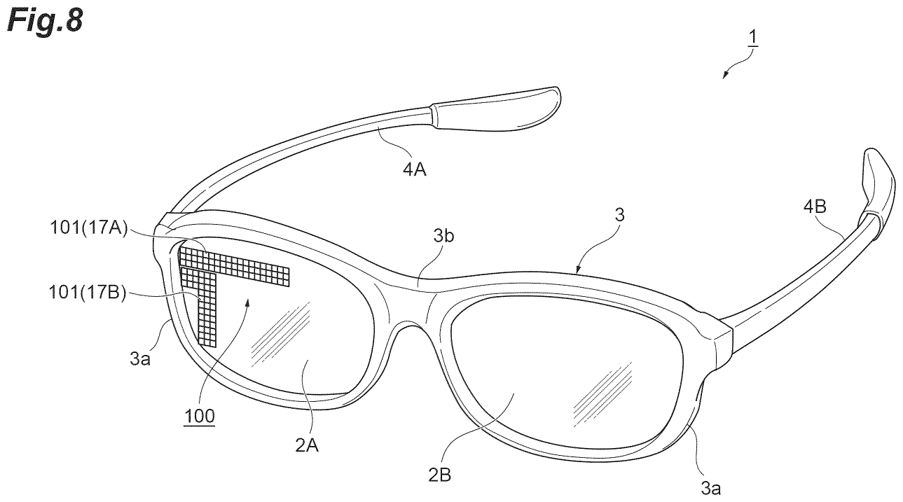

The conductor portion 12 can be arranged in a bent state. Moreover, the conductor portion 12 can be arranged in a state where at least a part of the first conductor pattern 16 and at least a part of the second conductor pattern 17 extend in different directions. Here, the different directions are directions intersecting three-dimensionally. Therefore, in the present embodiment, at least a part of the second conductor pattern 17 extends in a direction intersecting the plane of the ground pattern 11 and the first conductor pattern 16. That is, the configuration in which at least a part of the first conductor pattern 16 and at least a part of the second conductor pattern 17 can be arranged to extend in different directions is different from a shape in which a part of the conductor pattern and a part of the conductor pattern are formed in an L-shape in the same plane (for example, a shape like the L-shaped second conductor pattern 17B in FIG. 8). The conductor portion 12 can be arranged in a bent state at the connection portion 24 between the first conductor pattern 16 and the second conductor pattern 17 (see also FIG. 2). The connection portion 24 also corresponds to the connection portion between the antenna portion 101 and the circuit portion 102. As shown in FIGS. 3A to 3C, the antenna portion 101 may have a structure that can be bent from a state in which the antenna portion 101 extends in the same direction as the circuit portion 102 to the bent state as shown in FIG. 2. In addition, the bent state at the connection portion 24, for example, may be a state in which the second conductor pattern 17 at the connection portion 24 can be bent by employing a flexible material as the substrate 13 of the antenna portion 101 as well as a bent state at a portion located at a boundary between the first conductor pattern 16 and the second conductor pattern 17. Moreover, a flexible base board is employed as the material of the base board 10, and therefore the first conductor pattern 16 at the connection portion 24 may be able to be bent. However, in this case, a portion that bends and extends to the lens body side of the first conductor pattern 16 needs to be bent to fit into the frame of the lens body. Alternatively, as shown in FIG. 2, a device in which the antenna portion 101 is bent with the circuit portion 102 may be manufactured.

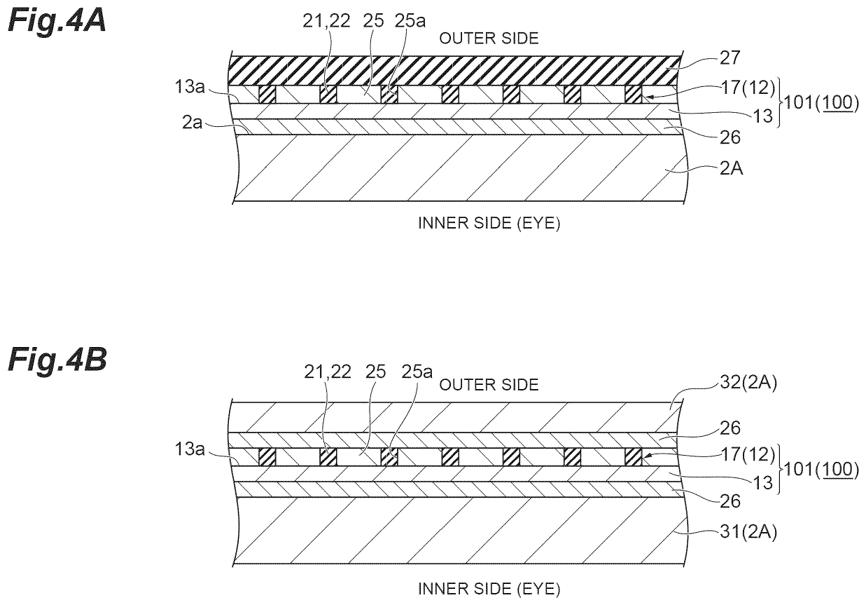

A cross-sectional structure of the antenna portion 101 and a cross-sectional structure when the antenna portion 101 is mounted on the lens body 2A will be described in detail with reference to FIG. 4A. As shown in FIG. 4A, the second conductor pattern 17 may be arranged in a mesh-like trench 25a of the resin layer 25 provided on the front surface 13a of the substrate 13. In the example shown in FIG. 4A, the trench 25a penetrates the resin layer 25. In this case, the thicknesses of the second conductor pattern 17 and the resin layer 25 are equal. The thickness is not particularly limited, but may be set to, for example, 0.5 to 5 μm. In addition, the trench 25a may not penetrate the resin layer 25. Moreover, the thickness of the second conductor pattern 17 may be smaller than the thickness of the resin layer 25.

The resin layer 25 is formed of a resin having light transmission, and a flat surface is formed between the resin layer 25 and the second conductor pattern 17 normally. The total light transmittance of the resin layer 25 may be 90 to 100%. A haze of the resin layer 25 may be 0 to 5%. A difference between refractive indices of the substrate 13 and the resin layer 25 may be 0.1 or less. The refractive index (nd25) of the resin layer 25 may be, for example, 1.0 or more, 1.7 or less, 1.6 or less, or 1.5 or less. The refractive index can be measured with a reflection spectroscopic film thickness gauge.

The resin forming the resin layer 25 may be a cured product of a curable resin composition (a photocurable resin composition or a thermosetting resin composition). The curable resin composition forming the resin layer 25 includes a curable resin, and examples thereof include an acrylic resin, amino resin, cyanate resin, isocyanate resin, polyimide resin, epoxy resin, oxetane resin, polyester, allyl resin, phenolic resin, benzoxazine resin, xylene resin, ketone resin, furan resin, COPNA resin, silicon resin, dicyclopentadiene resin, benzocyclobutene resin, episulfide resin, ene-thiol resin, poly azomethine resin, polyvinyl benzyl ether compound, acenaphthylene, and ultraviolet-curable resin containing unsaturated double bonds and a functional group causing a polymerization reaction with ultraviolet rays such as cyclic ether and vinyl ether.

The substrate 13 has light transmission to the extent required when the wiring body 100 is incorporated into the smart glasses 1. Specifically, the total light transmittance of the substrate 13 may be 90 to 100%. The haze of the substrate 13 may be 0 to 5%. The substrate 13 may be, for example, a transparent resin film, and examples thereof include films of polyethylene terephthalate (PET), polycarbonate (PC), polyethylene naphthalate (PEN), cycloolefin polymer (COP), and polyimide (PI). Alternatively, the substrate 13 may be a glass base board. The thickness of the substrate 13 is not particularly limited, but may be set to, for example, 10 to 200 μm.

The substrate 13 of the antenna portion 101 is bonded to the main surface 2a of the lens body 2A via an adhesive sheet 26. The material of the adhesive sheet 26 is not particularly limited, but for example, optical clear adhesive (OCA) or optical clear resin (OCR) may be employed. The thickness of the adhesive sheet 26 is not particularly limited, but may be set to, for example, 50 to 200 μm.

As the lens body 2A, for example, a plastic lens, a glass lens, or the like may be employed. The material of the lens body 2A is not particularly limited as long as it is a resin material having excellent transparency and a low refractive index, and for example, polymethyl methacrylate (PMMA), polycarbonate (PC) as another material, or the like may be employed. The thickness of the lens body 2A may be appropriately adjusted in accordance with the user's visual acuity and the like.

The second conductor pattern 17 of the antenna portion 101 may be covered with an insulation layer 27 on an opposite side of the lens body 2A. The insulation layer 27 is not particularly limited as long as it is a resin material having a lower dielectric constant than the constituent members of the lens body 2A and having excellent transparency and weather resistance, and, for example, polycarbonate (PC) may be employed. A thickness of the insulation layer 27 is not particularly limited, but may be set to, for example, 100 to 200 μm. A dielectric constant of the insulation layer 27 may be set to, for example, 2.7 to 3.0. A dielectric constant of the lens body 2A may be set to, for example, 3.0 to 4.3.

The layer configuration in the lens body 2A is not limited to that shown in FIG. 4A, and can be appropriately changed. For example, the layer configuration shown in FIG. 4B may be employed. In FIG. 4B, the lens body 2A has an inner lens portion 31 and an outer lens portion 32. The antenna portion 101 is arranged so that the antenna portion 101 is sandwiched between the inner lens portion 31 and the outer lens portion 32. The outer lens portion 32 is bonded to the second conductor pattern 17 via the adhesive sheet 26. Thereby, the second conductor pattern 17 is protected by the outer lens portion 32 instead of the insulation layer 27. The outer lens portion 32 may be thinner than the inner lens portion 31. The outer lens portion 32 may employ a material similar to that of the inner lens portion 31 (the lens body 2A of FIG. 4A).

Next, the action and effect of the wiring body 100 and the smart glasses 1 according to the present embodiment will be described.

According to the present embodiment, the wiring body 100 includes the base board 10; the ground pattern 11 provided on the base board 10; and the conductor portion 12 including the first conductor pattern 16 and the second conductor pattern 17 containing metal, wherein the ground pattern 11 is a conductor pattern extending so as to form a planar surface, wherein the second conductor pattern 17 is a mesh-like conductor pattern connected to the first conductor pattern 16, and wherein the conductor portion 12 is able to be arranged in a bent state. Here, the conductor portion 12 can be arranged in a bent state at a connection portion between the first conductor pattern 16 and the second conductor pattern 17.

In the wiring body 100, the conductor portion 12 can be arranged in a bent state. Here, the conductor portion 12 can be arranged in a bent state at the connection portion 24 between the first conductor pattern 16 and the second conductor pattern 17. Therefore, the second conductor pattern 17 can be disposed at the lens body 2A side of the smart glasses, and the first conductor pattern can be disposed at the temple arm 4A side together with the base board 10. Accordingly, the second conductor pattern 17 can function as the antenna portion 101 provided on the lens body 2A. Here, the second conductor pattern 17 is a mesh-like conductor pattern. Therefore, the visibility of the conductor pattern of the antenna portion 101 on the lens body 2A can be suppressed. Moreover, the second conductor pattern 17 of the antenna portion 101 is formed to be mesh-like, and therefore the resistance of the antenna portion 101 can be lowered compared to a case where the antenna portion 101 includes a transparent electrode. Here, because the ground pattern 11 is arranged in the temple arm 4A, it does not need to be mesh-like, a transparent electrode, or the like because it does not affect visibility. Accordingly, the ground pattern 11 provided on the base board 10 is a conductor pattern extending so as to form a planar surface. Thereby, the ground pattern 11 has low resistance, and therefore the characteristics of the antenna portion 101 can be improved. As described above, the visibility of the conductor pattern of the antenna can be suppressed and the characteristics of the antenna can be improved. Moreover, the mesh-like second conductor pattern 17 is used, and therefore the antenna portion 101 can be provided on the lens body 2A while following the bent shape of the lens body 2A.

The sheet resistance of the second conductor pattern 17 may be 1Ω/□ or less. Thereby, the antenna portion 101 can be made to have low resistance.

When the length of the second conductor pattern 17 is denoted by A, the length of the ground pattern 11 is denoted by B, and the wavelength of the resonant frequency is denoted by λ, Inequality (1) may be satisfied. In this case, the length of the ground pattern 11 can be sufficiently larger than the length of the second conductor pattern. Thereby, the antenna characteristics can be improved.

$$A - λ / 4 < B - A \qquad ( 1 )$$

The second conductor pattern 17 may be arranged in a mesh-like trench 25a of the resin layer 25 provided in the substrate 13. Thereby, the second conductor pattern 17 can be firmly fixed in the lens body 2A.

According to the present embodiment, the wiring body 100 includes the base board 10; the ground pattern 11 provided on the base board 10; and the conductor portion 12 including the first conductor pattern 16 and the second conductor pattern 17 containing metal, wherein the ground pattern 11 is a conductor pattern extending so as to form a planar surface, wherein the second conductor pattern 17 is a mesh-like conductor pattern connected to the first conductor pattern 16, and wherein the conductor portion 12 is able to be arranged in a bent state. Here, the conductor portion 12 can be arranged in a state where at least a part of the first conductor pattern 16 and at least a part of the second conductor pattern 17 extend in different directions.

In the wiring body 100, the conductor portion 12 can be arranged in a state where at least a part of the first conductor pattern 16 and at least a part of the second conductor pattern 17 extend in different directions. Here, the conductor portion 12 can be arranged in a bent state at the connection portion 24 between the first conductor pattern 16 and the second conductor pattern 17. Therefore, the second conductor pattern 17 can be disposed at the lens body 2A side of the smart glasses, and the first conductor pattern can be disposed at the temple arm 4A side together with the base board 10. Accordingly, the second conductor pattern 17 can function as the antenna portion 101 provided on the lens body 2A. Here, the second conductor pattern 17 is a mesh-like conductor pattern. Therefore, the visibility of the conductor pattern of the antenna portion 101 on the lens body 2A can be suppressed. Moreover, the second conductor pattern 17 of the antenna portion 101 is formed to be mesh-like, and therefore the resistance of the antenna portion 101 can be lowered compared to a case where the antenna portion 101 includes a transparent electrode. Here, because the ground pattern 11 is arranged in the temple arm 4A, it does not need to be mesh-like or a transparent electrode because it does not affect visibility. Accordingly, the ground pattern 11 provided on the base board 10 is a conductor pattern extending so as to form a planar surface. Thereby, the ground pattern 11 has low resistance, and therefore the characteristics of the antenna portion 101 can be improved. As described above, the visibility of the conductor pattern of the antenna can be suppressed and the characteristics of the antenna can be improved. Moreover, the mesh-like second conductor pattern 17 is used, and therefore the antenna portion 101 can be provided on the lens body 2A while following the bent shape of the lens body 2A.

The smart glasses 1 according to the present embodiment include the pair of lens bodies 2A and 2B, the temple arms 4A and 4B arranged on both sides of the pair of lens bodies 2A and 2B, and the above-described wiring body 100, wherein the second conductor pattern 17 is disposed at the lens body 2A and the base board 10 is disposed at the temple arm 4A.

According to the smart glasses 1, the second conductor pattern 17 is disposed at the lens body 2A and the base board 10 is disposed at the temple arm 4A, and therefore the action and effect similar to those of the wiring body 100 described above can be obtained.

The smart glasses 1 may further include the insulation layer 27 configured to cover an opposite side of the lens body 2A within the second conductor pattern 17, wherein the dielectric constant of the insulation layer 27 may be lower than the dielectric constant of the constituent members of the lens body 2A. In this case, a portion of the second conductor pattern 17 facing outward in the opposite side of the lens body 2A can be protected by the insulation layer 27 having high insulation properties. Moreover, by lowering the dielectric constant of the insulation layer 27, an influence in the radiation characteristics can be suppressed.

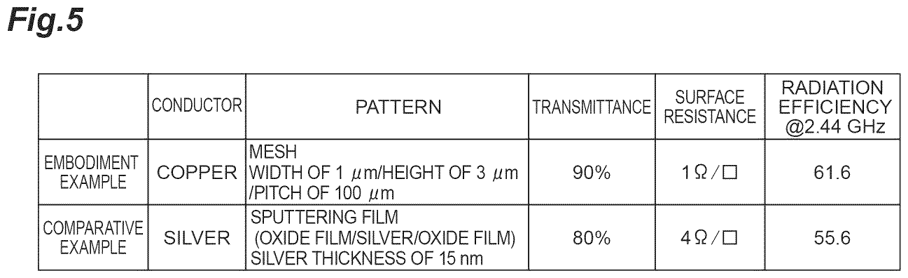

The characteristics of the smart glasses 1 according to the embodiment example and the smart glasses according to the comparative example will be described with reference to FIG. 5. The smart glasses 1 according to the embodiment example employ the mesh-like second conductor pattern 17 having a width of 1 μm, a height of 3 μm, and a pitch of 100 μm as a conductor of the antenna portion. The material of the second conductor pattern 17 is copper. The smart glasses according to the comparative example employed a silver transparent electrode using a sputtering film as the conductor of the antenna portion. A film composition of the sputtering film was “oxide film/silver/oxide film” and the silver film thickness was 15 nm. The transmittance of the antenna portion 101 of the smart glasses 1 according to the embodiment example was 90%, and the surface resistance was 1Ω/□. The transmittance of the antenna portion 101 of the smart glasses according to the comparative example was 80%, and the surface resistance was 4Ω/□. When the radiation efficiency of these smart glasses was measured at 2.44 GHZ, the measured radiation efficiency was 61.6% in the embodiment example compared to 55.6% in the comparative example, and it was confirmed that the radiation efficiency was improved.

The present disclosure is not limited to the above-described embodiments.

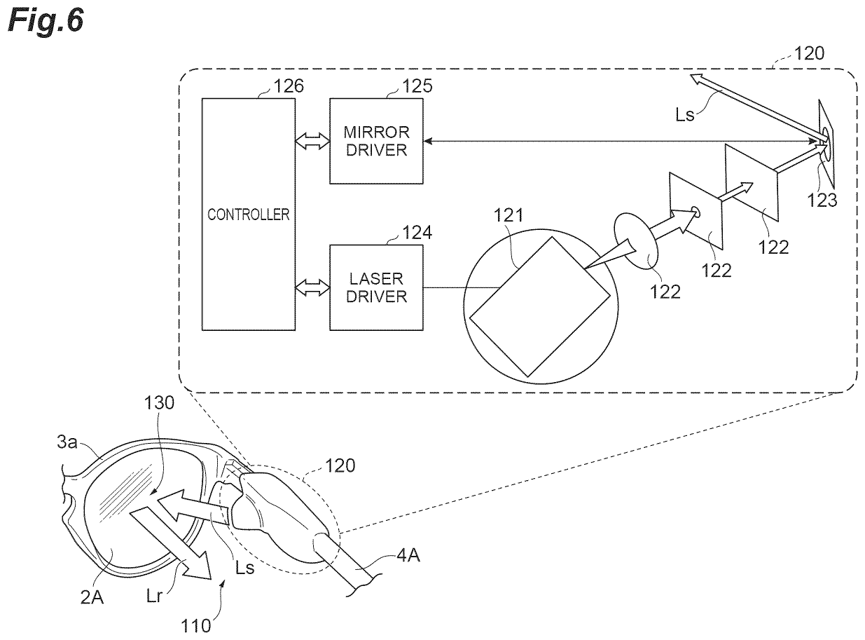

For the above-described smart glasses 1, a configuration for projecting a video onto the lens body 2A may be provided. For example, a projection device 110 as shown in FIG. 6 may be provided on the temple arm 4A. The projection device 110 includes an optical engine 120 and a metasurface reflector 130.

The optical engine 120 is a device that generates laser light Ls having a color and intensity corresponding to pixels of a video projected onto the retina and emits the laser light Ls to the metasurface reflector 130. The optical engine 120 includes a light source unit 121 (a light source), an optical component 122, a movable mirror 123, a laser driver 124, a mirror driver 125, and a controller 126. In the optical engine 120, laser light having a color and intensity corresponding to the pixels of the video projected onto the retina is emitted from the light source unit 121, passes through the optical component 122, and is reflected by the movable mirror 123. The laser light reflected by the movable mirror 123 is emitted to the metasurface reflector 130 as the laser light Ls. The reflected light Lr reflected by the metasurface reflector 130 enters the user's retina as a video. The laser driver 124 drives the light source unit 121, and the mirror driver 125 drives the movable mirror 123. The controller 126 controls the laser driver 124 and the mirror driver 125.

In addition, as a configuration in which a video is projected onto the lens body 2A, a configuration in which a mechanism for displaying a video on the lens body 2A itself may be employed instead of the above-described configuration shown in FIG. 6.

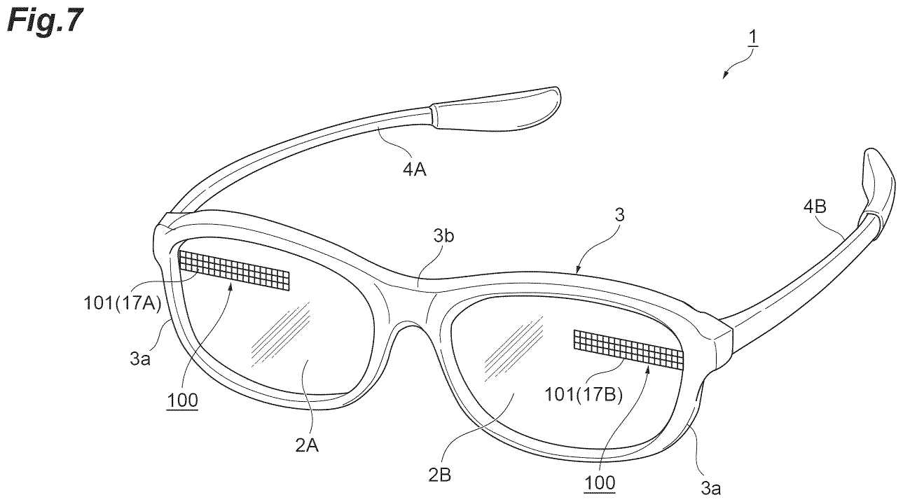

Moreover, the smart glasses 1 may have a plurality of second conductor patterns 17 and at least one second conductor pattern 17 may be disposed at each of the lens body 2A on the right-eye side and the lens body 2B on the left-eye side. For example, as shown in FIG. 7, a second conductor pattern 17B of the lens body 2B on the left-eye side may be provided in addition to the second conductor pattern 17A of the lens body 2A on the right-eye side. In this case, because the smart glasses 1 have the antenna portion 101 on both the right-eye side and the left-eye side, the antenna characteristics can be improved. In addition, the circuit portion 102 may be provided in the temple arm 4B on the left side with respect to the second conductor pattern 17B on the left-eye side.

Moreover, the smart glasses 1 may have a plurality of second conductor patterns 17 and a plurality of second conductor patterns 17 may be arranged on either one of the lens body 2A on the right-eye side and the lens body 2B on the left-eye side. For example, as shown in FIG. 8, a second conductor pattern 17A and another second conductor pattern 17B may be arranged on the lens body 2A on the right-eye side. In this case, each of the second conductor pattern 17A and the second conductor pattern 17B can be operated as an antenna. That is, because the antenna portion 101 can be provided at a plurality of locations in one lens body 2A, the antenna characteristics can be improved. Moreover, if a plurality of second conductor patterns 17 are provided in one lens body 2A, the circuit portion 102 provided in the temple arm 4A on the right side can be shared. However, one or more second conductor patterns 17 may be arranged on the lens body 2B on the left-eye side with respect to the form of FIG. 8.

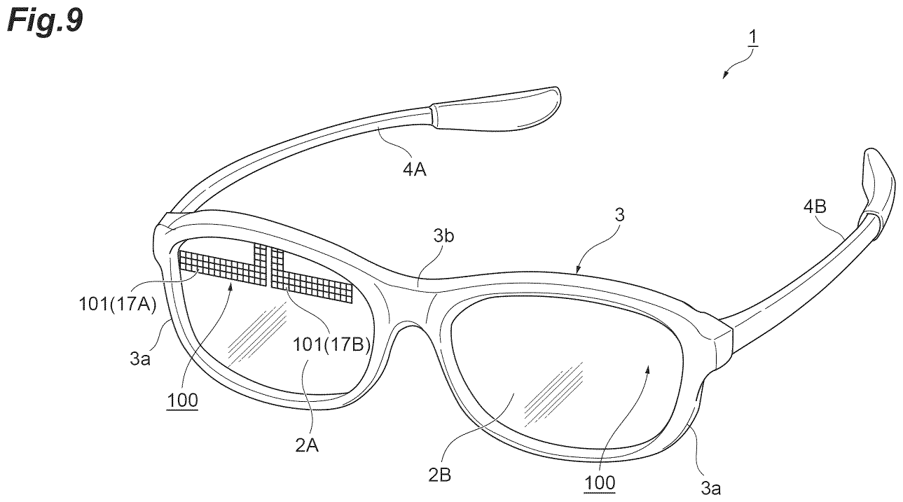

Moreover, the extension direction of the plurality of second conductor patterns 17 may be different from each other. For example, in FIG. 8, the second conductor pattern 17A extends in the left and right directions as the extension direction and the second conductor pattern 17B extends in the vertical direction as the extension direction. Because the antenna portion 101 can be provided in a wide range, the antenna characteristics can be improved. In addition, in the form of FIG. 8, a dipole antenna may include the second conductor pattern 17A and the second conductor pattern 17B. In this case, there is no influence of the size of the ground pattern 11 and stable antenna characteristics can be obtained. Moreover, as shown in FIG. 9, the second conductor pattern 17A may be extended in the left direction as the extension direction and the second conductor pattern 17B may be extended in the right direction as the extension direction.

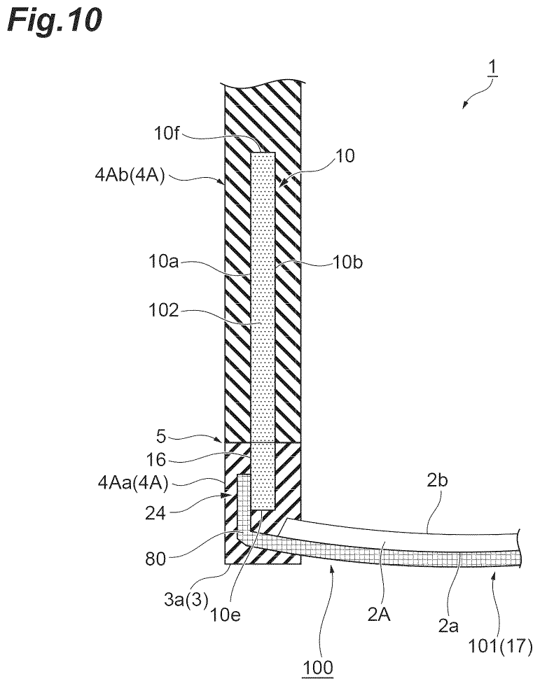

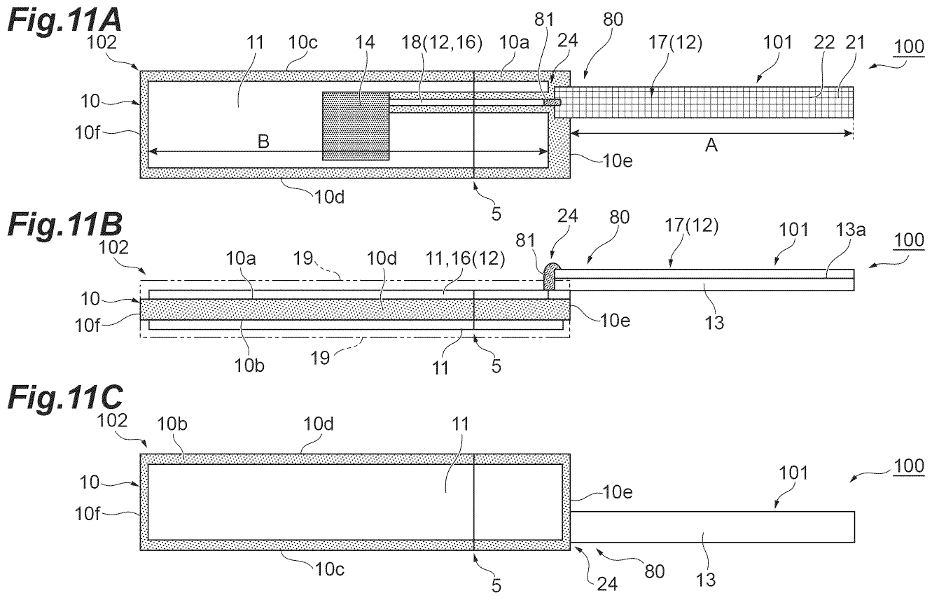

The connection mode between the first conductor pattern 16 and the second conductor pattern 17 is not limited to the configuration shown in FIGS. 2 and 3A to 3C. For example, the configuration shown in FIGS. 10 and 11A to 11C may be employed. As shown in FIG. 10, the antenna portion 101 having the second conductor pattern 17 is bent at the bent portion 80 within the frame 3 and extends to the front surface 10a side of the circuit portion 102. Moreover, the second conductor pattern 17 is connected to the first conductor pattern 16 at a location on the front surface 10a side of the circuit portion 102. In this configuration, the connection portion 24 is provided at a location on the front surface 10a side of the circuit portion 102. In this configuration, the conductor portion 12 can be arranged in a bent state. Moreover, in this configuration, the conductor portion 12 can be arranged in a state where at least a part of the first conductor pattern 16 and at least a part of the second conductor pattern 17 extend in different directions. In the plan view shown in FIG. 11A, the second conductor pattern 17 extends to a position overlapping with the edge portion near the side surface 10e of the base board 10. As shown in FIGS. 11A and 11B, the transmission line 18 of the first conductor pattern 16 and the second conductor pattern 17 are electrically connected at the connection portion 24 via a bonding member 81. The bonding member 81 is not particularly limited, but solder or conductive paste may be employed.

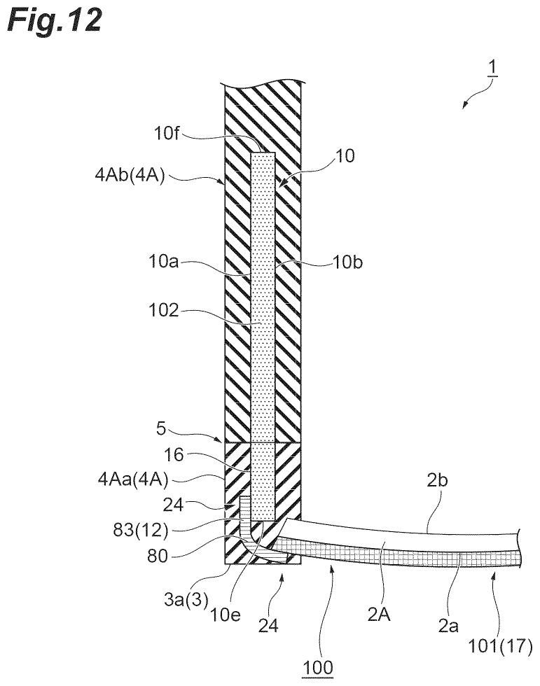

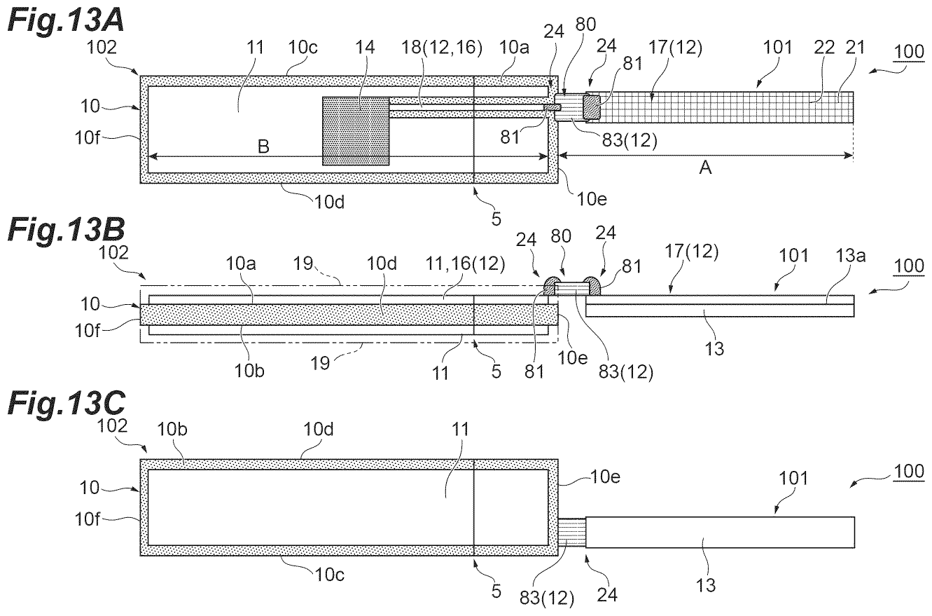

Moreover, the configuration shown in FIGS. 12 and 13A to 13C may be employed. As shown in FIG. 12, the second conductor pattern 17 is connected to the first conductor pattern 16 via a flexible base board 83. At this time, the flexible base board has a bent portion 80. The connection portion 24 is provided at a location where the flexible base board 83 and the first conductor pattern 16 are connected, and the connection portion 24 is provided at a location where the flexible base board 83 and the second conductor pattern 17 are connected. In this configuration, the conductor portion 12 includes the conductor pattern of the flexible base board 83 in addition to the first conductor pattern 16 and the second conductor pattern 17. In this configuration, the conductor portion 12 can be arranged in a bent state. Moreover, in this configuration, the conductor portion 12 can be arranged in a state where at least a part of the first conductor pattern 16 and at least a part of the second conductor pattern 17 extend in different directions. In the plan view shown in FIG. 13A, the flexible base board 83 is arranged near the end portion of the second conductor pattern 17 and near the edge portion of the side surface 10e of the base board 10. The end portion of the second conductor pattern 17 and the side surface 10e of the base board 10 are arranged at positions spaced apart from each other. As shown in FIGS. 13A and 13B, the transmission line 18 of the first conductor pattern 16 and the flexible base board 83 are electrically connected at the connection portion 24 via a bonding member 81. The second conductor pattern 17 and the flexible base board 83 are electrically connected at the connection portion 24 via a bonding member 81.

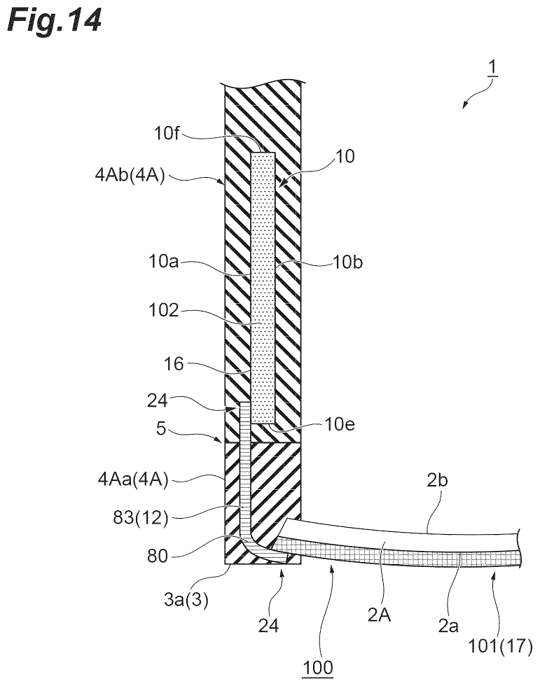

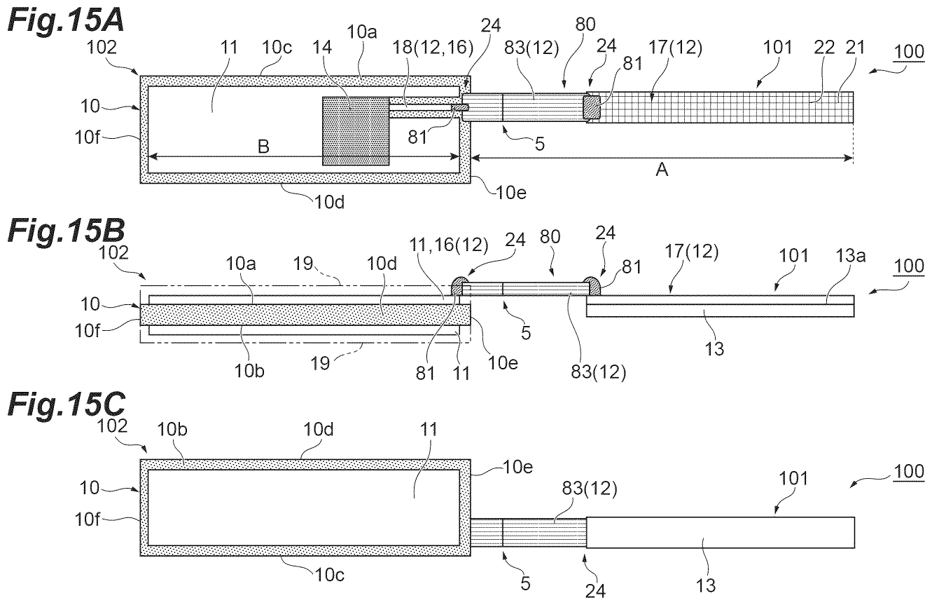

Moreover, the configuration shown in FIGS. 14 and 15A to 15C may be employed. As shown in FIG. 14, the second conductor pattern 17 is connected to the first conductor pattern 16 via a flexible base board 83. At this time, the flexible base board has a bent portion 80. Furthermore, the flexible base board 83 extends to a location on the side surface 10f side of the circuit portion 102, that is, to a location of the second portion 4Ab beyond the joint portion 5. A portion existing within the first portion 4Aa of the circuit portion 102 is omitted. The connection portion 24 is provided at a location where the flexible base board 83 and the first conductor pattern 16 are connected, and the connection portion 24 is provided at a location where the flexible base board 83 and the second conductor pattern 17 are connected. In this configuration, the conductor portion 12 includes the conductor pattern of the flexible base board 83 in addition to the first conductor pattern 16 and the second conductor pattern 17. In this configuration, the conductor portion 12 can be arranged in a bent state. Moreover, in this configuration, the conductor portion 12 can be arranged in a state where at least a part of the first conductor pattern 16 and at least a part of the second conductor pattern 17 extend in different directions. In the plan view shown in FIG. 15A, the flexible base board 83 is arranged near the end portion of the second conductor pattern 17 and near the edge portion of the side surface 10e of the base board 10. It overlaps with a location reaching the vicinity of the joint portion 5. The end portion of the transmission line 18 is formed on the flexible base board 83 at the joint portion 5. The end portion of the second conductor pattern 17 and the side surface 10e of the base board 10 are arranged at positions spaced apart from each other. As shown in FIGS. 15A and 15B, the transmission line 18 of the first conductor pattern 16 and the flexible base board 83 are electrically connected at the connection portion 24 via a bonding member 81. The second conductor pattern 17 and the flexible base board 83 are electrically connected at the connection portion 24 via a bonding member 81.

### [Form 1]

A wiring body including:
a base board;
a ground pattern provided on the base board; and
a conductor portion including a first conductor pattern and a second conductor pattern containing metal,
wherein the ground pattern is a conductor pattern extending so as to form a planar surface,
wherein the second conductor pattern is a mesh-like conductor pattern connected to the first conductor pattern, and
wherein the conductor portion is able to be arranged in a bent state at.

### [Form 2]

The wiring body according to form 1, wherein sheet resistance of the second conductor pattern is 1Ω/□ or less.

### [Form 3]

The wiring body according to form 1 or 2, wherein, when a length of the second conductor pattern is denoted by A, a length of the ground pattern is denoted by B, and a wavelength of a resonant frequency is denoted by λ, Inequality (1) is satisfied.

$$\begin{matrix}[ Form 4 ] & \\ A - λ / 4 < B - A & ( 1 )\end{matrix}$$

The wiring body according to any one of forms 1 to 3, wherein the second conductor pattern is arranged inside a mesh-like trench of a resin layer provided on a substrate.

### [Form 5]

A wiring body comprising:
a base board;
a ground pattern provided on the base board; and
a conductor portion including a first conductor pattern and a second conductor pattern containing metal,
wherein the ground pattern is a conductor pattern extending so as to form a planar surface,
wherein the second conductor pattern is a mesh-like conductor pattern connected to the first conductor pattern, and
wherein the conductor portion is able to be arranged in a state where at least a part of the first conductor pattern and at least a part of the second conductor pattern extend in different directions.

### [Form 6]

Smart glasses comprising:
a pair of lens bodies;
temple arms arranged on both sides of the pair of lens bodies; and
the wiring body according to any one of forms 1 to 5,
wherein the second conductor pattern is disposed at the lens body and the base board is disposed at the temple arm.

### [Form 7]

The smart glasses according to form 6, further including an insulation layer configured to cover an opposite side of the lens body within the second conductor pattern,
wherein the dielectric constant of the insulation layer is less than a dielectric constant of a constituent member of the lens body.

### [Form 8]

The smart glasses according to form 6,
wherein the lens body includes an inner lens portion and an outer lens portion,
wherein the second conductor pattern is arranged between the inner lens portion and the outer lens portion, and
wherein a thickness of the outer lens portion is thinner than a thickness of the inner lens portion.

### [Form 9]

The smart glasses according to any one of forms 6 to 8,
wherein the number of second conductor patterns is two or more, and
wherein at least one second conductor pattern is arranged on each of the lens body on a left-eye side and the lens body on a right-eye side.

### [Form 10]

The smart glasses according to any one of forms 6 to 9,
wherein the number of second conductor patterns is two or more, and
wherein a plurality of second conductor patterns are arranged on either one of the lens body on a right-eye side and the lens body on a left-eye side.

### [Form 11]

The smart glasses according to form 10, wherein the extension direction of the plurality of second conductor patterns are different from each other.

### REFERENCE SIGNS LIST

1 Smart glasses
2A, 2B Lens body
4A, 4B Temple arm
10 Base board
11 Ground pattern
12 Conductor portion
13 Substrate
16 First conductor pattern
17 Second conductor pattern
24 Connection portion
25 Resin layer
27 Insulation layer
100 Wiring body

What is claimed is:

1. A wiring body comprising:
a base board;
a ground pattern provided on the base board; and
a conductor portion including a first conductor pattern and a second conductor pattern containing metal,
wherein the ground pattern is a conductor pattern extending so as to form a planar surface,
wherein the second conductor pattern is a mesh-like conductor pattern connected to the first conductor pattern, and
wherein the conductor portion is able to be arranged in a bent state.

2. The wiring body according to claim 1, wherein sheet resistance of the second conductor pattern is 1Ω/□ or less.

3. The wiring body according to claim 1, wherein, when a length of the second conductor pattern is denoted by A, a length of the ground pattern is denoted by B, and a wavelength of a resonant frequency is denoted by λ, Inequality (1) is satisfied:
$$A - λ / 4 < B - A . \qquad ( 1 )$$

4. The wiring body according to claim 1, wherein the second conductor pattern is arranged inside a mesh-like trench of a resin layer provided on a substrate.

5. A wiring body comprising:
a base board;
a ground pattern provided on the base board; and
a conductor portion including a first conductor pattern and a second conductor pattern containing metal,
wherein the ground pattern is a conductor pattern extending so as to form a planar surface,
wherein the second conductor pattern is a mesh-like conductor pattern connected to the first conductor pattern, and
wherein the conductor portion is able to be arranged in a state where at least a part of the first conductor pattern and at least a part of the second conductor pattern extend in different directions.

6. Smart glasses comprising:
a pair of lens bodies;
temple arms arranged on both sides of the pair of lens bodies; and
the wiring body according to claim 1,
wherein the second conductor pattern is disposed at the lens body and the base board is disposed at the temple arm.

7. The smart glasses according to claim 6, further comprising an insulation layer configured to cover an opposite side of the lens body within the second conductor pattern,
wherein the dielectric constant of the insulation layer is less than a dielectric constant of a constituent member of the lens body.

8. The smart glasses according to claim 6,
wherein the lens body includes an inner lens portion and an outer lens portion,
wherein the second conductor pattern is arranged between the inner lens portion and the outer lens portion, and
wherein a thickness of the outer lens portion is thinner than a thickness of the inner lens portion.

9. The smart glasses according to claim 6,
wherein the number of second conductor patterns is two or more, and
wherein at least one second conductor pattern is arranged on each of the lens body on a left-eye side and the lens body on a right-eye side.

10. The smart glasses according to claim 6,
wherein the number of second conductor patterns is two or more, and
wherein a plurality of second conductor patterns are arranged on either one of the lens body on a right-eye side and the lens body on a left-eye side.

11. The smart glasses according to claim 10, wherein the extension direction of the plurality of second conductor patterns are different from each other.

12. Smart glasses comprising:
a pair of lens bodies;
temple arms arranged on both sides of the pair of lens bodies; and
the wiring body according to claim 5,
wherein the second conductor pattern is disposed at the lens body and the base board is disposed at the temple arm.

13. The smart glasses according to claim 12, further comprising an insulation layer configured to cover an opposite side of the lens body within the second conductor pattern,
wherein the dielectric constant of the insulation layer is less than a dielectric constant of a constituent member of the lens body.

14. The smart glasses according to claim 12,
wherein the lens body includes an inner lens portion and an outer lens portion,
wherein the second conductor pattern is arranged between the inner lens portion and the outer lens portion, and
wherein a thickness of the outer lens portion is thinner than a thickness of the inner lens portion.

15. The smart glasses according to claim 12,
wherein the number of second conductor patterns is two or more, and
wherein at least one second conductor pattern is arranged on each of the lens body on a left-eye side and the lens body on a right-eye side.

16. The smart glasses according to claim 12,
wherein the number of second conductor patterns is two or more, and
wherein a plurality of second conductor patterns are arranged on either one of the lens body on a right-eye side and the lens body on a left-eye side.

17. The smart glasses according to claim 16, wherein the extension direction of the plurality of second conductor patterns are different from each other.
